(19) United States
(12) Patent Application Publication
(10) Pub. No.: US 2023/0405726 A1
(43) Pub. Date: Dec. 21, 2023

(54) SUBSTRATE CARRIER MADE OF GLASS FOR PROCESSING A SUBSTRATE AND A METHOD FOR MANUFACTURE OF THE SUBSTRATE CARRIER

(71) Applicant: LPKF Laser & Electronics SE, Garbsen (DE)

(72) Inventors: Daniel Dunker, Hannover (DE); Moritz Doerge, Uetze (DE); Roman Ostholt, Langenhagen (DE); Norbert Ambrosius, Garbsen (DE)

(21) Appl. No.: 18/337,541

(22) Filed: Jun. 20, 2023

(30) Foreign Application Priority Data
Jun. 21, 2022 (DE) 10 2022 115 457.2
Apr. 21, 2023 (DE) 10 2023 110 225.7

(51) Int. Cl. B23K 26/364; B23K 26/40; B23K 26/384; B23K 26/0622

(52) U.S. Cl. CPC B23K 26/364; B23K 26/40; B23K 26/384; B23K 26/0622; B23K 2103/54

(57) ABSTRACT

A substrate carrier made of glass for processing a transparent or transmissive substrate by electromagnetic radiation includes a first upper side serving as a substrate support and a lower side facing away from the upper side. The substrate support and/or the lower side of the substrate carrier has a structuring produced by modifications in the substrate carrier and a material removal by action of an etching medium in respective regions of the modifications in the substrate carrier. The structuring has a plurality of adjacent and/or merging conical recesses. At least one of the conical recesses is configured as a through-hole of the substrate carrier between the substrate support and the lower side, and a plurality of other ones of the conical recesses are configured as depressions.

### CROSS REFERENCE TO RELATED APPLICATIONS

This application claims benefit to German Patent Application No. DE 10 2022 115 457.2, filed on Jun. 21, 2022, and German Patent Application No. DE 10 2023 110 225.7, filed on Apr. 21, 2023, each of which is hereby incorporated by reference herein.

### FIELD

The invention relates to a substrate carrier made of glass for processing a substrate having a first upper side serving as a substrate support and a lower side facing away from the upper side, the substrate support and/or the lower side of the substrate carrier having a structuring. Furthermore, the invention relates to a method for manufacturing the substrate carrier by introducing modifications and subsequent exposure to an etching medium, whereby conical recesses are produced.

### BACKGROUND

A process for precision machining of glass using laser-induced deep etching has become known as LIDE (Laser Induced Deep Etching) for the creation of deep structures, such as through-holes or microcuts. LIDE technology makes it possible for the first time to realize modifications across the entire thickness of the glass with single laser pulses.

In deep etching, known for example from WO 2014/161 534 A2, a transparent material, for example a glass plate, is modified by means of a laser pulse or a pulse train over an elongated region along the beam axis, often over the entire thickness of the transparent material, and is then anisotropically etched in a wet-chemical etching bath.

From WO 2016/041 544 A1, a process for introducing a recess into a plate-shaped glass substrate by means of laser radiation is known, whereby anisotropic material removal occurs in the modified regions of the glass substrate due to the action of an etching medium by successive etching.

### SUMMARY

In an embodiment, the present invention provides a substrate carrier made of glass for processing a transparent or transmissive substrate by electromagnetic radiation. The substrate carrier includes a first upper side serving as a substrate support and a lower side facing away from the upper side. The substrate support and/or the lower side of the substrate carrier has a structuring produced by modifications in the substrate carrier and a material removal by action of an etching medium in respective regions of the modifications in the substrate carrier. The structuring has a plurality of adjacent and/or merging conical recesses. At least one of the conical recesses is configured as a through-hole of the substrate carrier between the substrate support and the lower side, and a plurality of other ones of the conical recesses are configured as depressions

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 a side view of a substrate carrier with recesses on one side;

FIG. 2 a side view of a substrate carrier with recesses on both sides;

FIG. 3 a side view of the substrate carrier shown in FIG. 1 during manufacture;

FIG. 4 the processing of a substrate on the substrate carrier shown in FIG. 1;

FIG. 5 different phases of the etching process during the manufacture of the substrate carrier; and

FIG. 6 the substrate carrier after completion in a top view.

### DETAILED DESCRIPTION

In an embodiment, the present invention provides a substrate carrier made of glass for processing a substrate by means of laser processing with a densely structured surface and a partial permeability of the material to negative pressure.

As preparatory measures, for example, different modifications are introduced into the material to be used by means of several different focus settings. In the first step, the ideal focus and power settings are determined and adjusted to create through-holes, the so-called through-glass vias (TGVs). In the second step, a modification referred to as type-I is created, which has a much weaker characteristic and can typically be produced at about half the power for TGVs.

When selecting the settings, it is important to ensure that the resulting cone-shaped recesses on the top and bottom sides are the same size after a subsequent etching process.

With a size of 50 μm, deviations of up to 4 μm between the upper and lower sides are acceptable.

Subsequently, large panels of size 300×300 mm² (preferably 500 μm material) are provided with a specific pattern, with low power modifications serving for cone-shaped recesses and higher power modifications serving for TGVs creating through-holes in the substrate carrier. The pitch of these modifications is 50 μm, which are in hexagonal arrangement. Thus, the spacing of the so-called “dice lines” is 45 μm. A complete project file for this application is available and is always applied to a large panel of size 300×300 mm².

A blank manufactured in this way can be produced in advance and then placed in stock. These blanks should be stored and marked separately to avoid confusion with other materials.

Such a blank is used to manufacture the substrate carrier. In accordance with the respective specifications, the outer edge geometry is first modified by the device according to existing process parameters for TGVs and the material thickness used for the plate-shaped material for the substrate carrier.

After the modification, the sheet-like material is reduced by 10% of its thickness by wet-chemical treatment. For 500 μm material, this means a reduction to 450 μm (typical process time: 50 minutes). In this condition, the final contour can be cut out of the 300×300 mm² panel. The sample with final outer contour is subsequently reduced by a further 10% of its thickness.

In this condition, all the conical recesses are etched large enough that the cone shapes have merged into one another and there are no longer any straight surfaces that still have a reflective capability when the substrate is processed by the electromagnetic radiation.

Through a camera only a black area can still be detected if the substrate carrier has a suitable pattern. If bright regions are still visible through the camera, which occur due to smooth glass surfaces, the etching process must be continued until the recesses have been etched large enough.

For each material and each material thickness, the laser process parameters must be determined individually. Identical materials exhibit identical taper properties. This results in the consequence that the total process time of the wet-chemical treatment remains identical, but the distribution between several wet-chemical process steps can change.

For alternative materials, the total process time of the wet-chemical process also changes. Thereby both the different etching rates and the differences in the taper angle must be taken into account. The total process time is thereby always based on the time required until all type-I modifications have “grown” into one another and the outer surface no longer contains any flat areas. The proportion of the first wet-chemical process step, on the other hand, depends on the process time that is required to achieve a through-hole (TGV).

By defining outer cutting edges, any fitting shapes for support surfaces smaller than a size 300×300 mm² can be realized.

Major advantages of the substrate carrier according to embodiments of the invention are a minimal contact area between the substrate carrier and the substrate to be processed. The negative pressure fixing the substrate during processing can act through the substrate carrier on the substrate to be processed.

Thereby the special shape of the substrate carrier ensures that the negative pressure is distributed over a large area on the substrate. This is made possible by the combination of through-holes through the substrate carrier between the substrate support and the lower side and several cone-shaped recesses as cone-shaped depressions. The cone-shaped depressions, which merge into one another, create a volume underneath the applied substrate, which can distribute the negative pressure.

The continuous angled shape of the substrate support increases its resistance to electromagnetic radiation during processing of the substrate. A coupling-in of the radiation is thus made more difficult, and the durability of the substrate carrier under the influence of the radiation is increased. Ablations on the substrate carrier by the radiation are prevented. The high angles of the substrate support surface ensure a total reflection of the laser light. A back reflection of the laser light is prevented by scattering on the substrate carrier.

Preferably, the micro-structured surface of the substrate support for processing substrates made of a material transparent to electromagnetic radiation has conical or cone-shaped recesses with a diameter of 5-150 μm, with a spacing p<0.95×D, in particular p<0.89×D, so that the material to be processed, in particular in the region of laser processing, rests on the substrate support over an area <1% of the substrate area, whereby the structuring can be limited to specific regions of the substrate support.

In another advantageous embodiment of the invention, a conductive coating, for example ITO, DLC, AZO, CNT (carbon nano tube) or a conductive metal coating such as, in particular, Cr, Ti, Mo, Au, Al on the upper and/or lower surface, serves to dissipate a static charge.

Absorbent, reflective and/or transparent properties have an advantageous effect on the coating, with the layer thickness preferably being less than 5 μm, in particular less than 3 μm or 1 μm.

A particularly preferred application of the substrate carrier made of glass arises in processes for laser processing of the substrate, wherein the substrate to be processed, in particular a transparent substrate, is in contact with the substrate carrier during processing with an average laser power of less than 500 W and/or a pulse energy of less than 500 μJ.

Due to the structuring, the substrate carrier is also preferably suitable for fixing very thin substrates with a material thickness of less than 100 μm, in particular less than 50 μm or 25 μm.

When processing a transparent or transmissive substrate by means of electromagnetic radiation, the radiation passes through the substrate into the substrate support, whereby an absorbent substrate support is strongly heated or removed, and, in addition, also undesirable effects on the substrate occur.

To counter this problem, the glass substrate carrier according to an embodiment of the invention has a micro-structured outer surface as substrate support. This results in a scattering of the radiation on the micro-structured surface, whereby an absorption is largely avoided. At the same time, thereby a minimization of the support areas is achieved due to a point contact with the substrate.

The through-holes serve to fix the negative pressure, whereby, according to a particularly practical configuration, structurings on both sides ensure a uniform distribution of the negative pressure, and a precise positioning relative to a connection of a negative pressure source can be dispensed with.

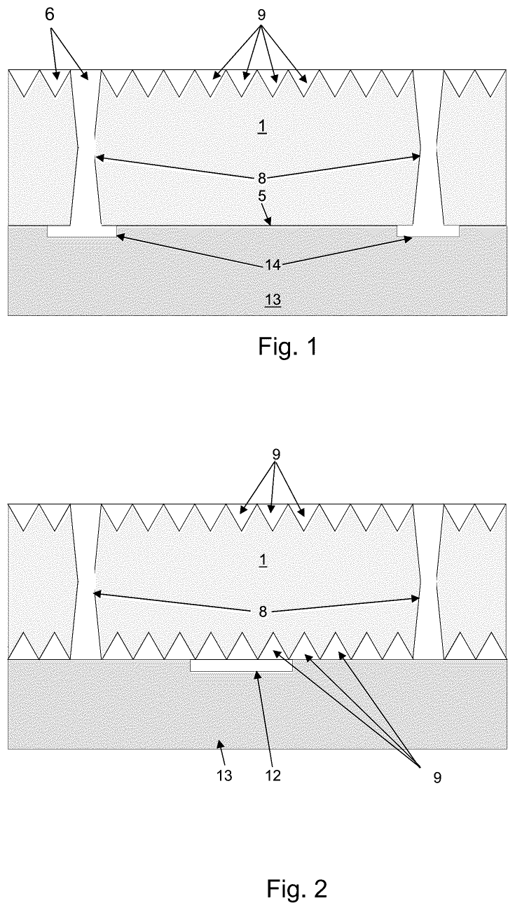

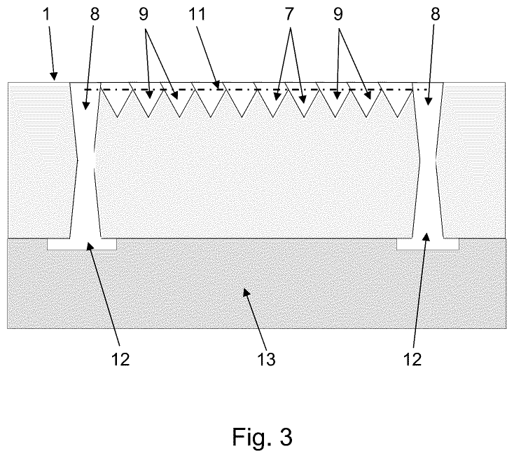

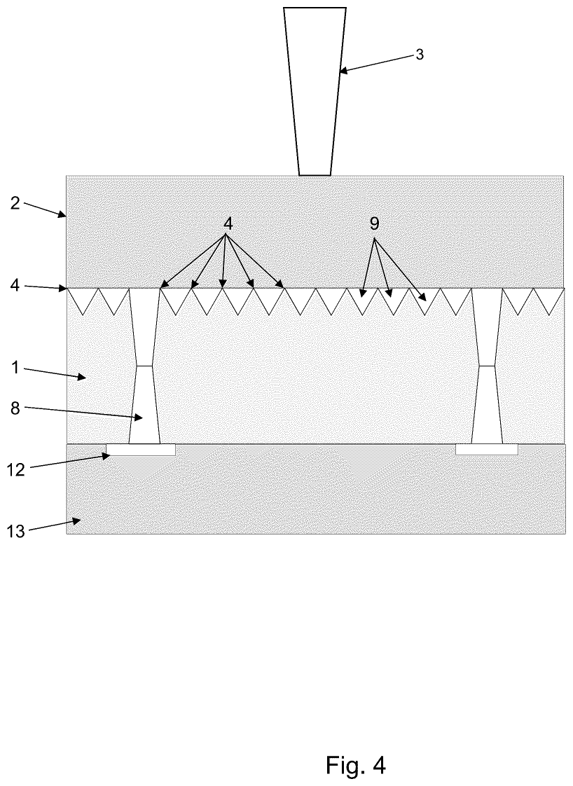

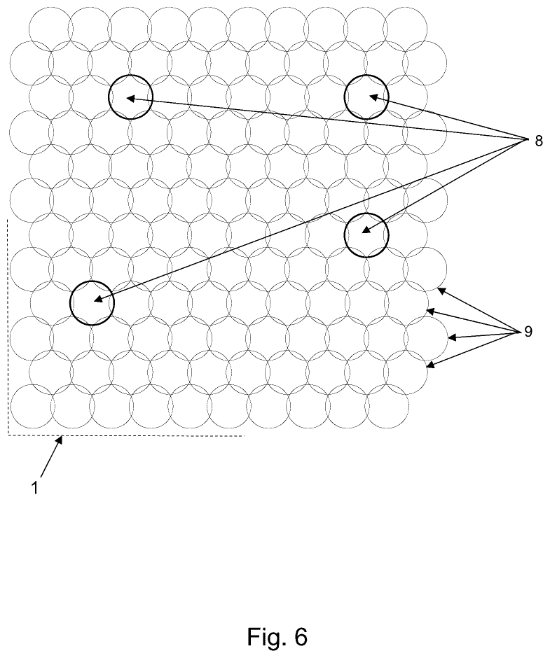

A plate-shaped substrate carrier 1 according to an embodiment of the invention and the method for its manufacture are explained in more detail below in FIGS. 1 to 6. The substrate carrier 1 consists of a transparent material, in particular glass, and is used for processing of a particularly transparent or transmissive substrate 2, by means of electromagnetic radiation 3, for example a laser, which passes through the substrate 2 during the processing thereof and would therefore strongly heat or remove an absorbent support, which has been common practice up to now.

For this purpose, the substrate carrier 1 has an upper side equipped with a substrate support 4 and a lower side 5, whereby according to the variant shown in FIG. 1, only the substrate support 4, and according to the variant shown in FIG. 2, the substrate support 4 and the lower side 5 of the substrate carrier 1, each have a structuring 6.

For the manufacturing of the substrate support 4 and the structured lower side 5 of the substrate carrier 1 shown in FIG. 2, the structurings 6 are introduced by a laser beam by first generating different modifications in the substrate carrier 1. By the action of an etching medium and by successive etching as a result of the anisotropic material removal in the respective region of the modifications within the substrate carrier 1, conical recesses 7 are subsequently formed. Thereby, as a result of the different modifications, several conical recesses 7 are formed, which are adjacent to one another and/or merge into one another, and which are formed either as a through-hole 8 of the substrate carrier 1 between the substrate support 4 and the lower side 5, or as conical depressions 9 without perforation of the substrate carrier 1.

Adjacent recesses 7 are separated from one another only by a wall surface 10, which extends to the common plane 11 of the punctiform substrate support 4 thus created. For this purpose, the etching process is stopped when the surface and/or wall area 10 consists only of peaks, which lie at least approximately in a common plane preferably corresponding to the original glass surface.

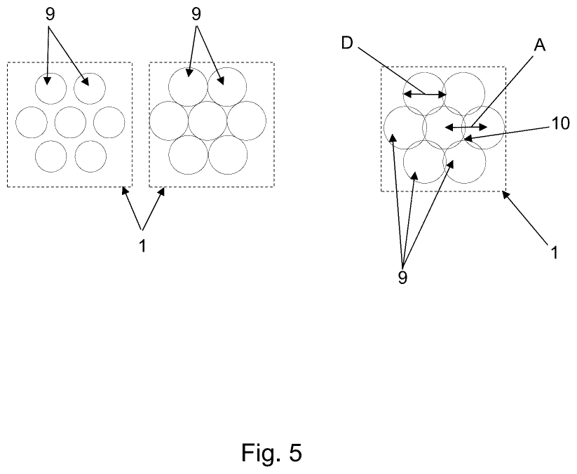

As can be seen in FIG. 5, the recesses 7 are initially produced in the etching process as cone-shaped depressions 9 without a through-hole 8. The etching process is then continued until the thickness of the wall surfaces 10 is reduced to a minimum and the wall surfaces are of such small thickness that regions parallel to a main extension plane of the supported substrate 2 and/or orthogonal to the incident electromagnetic radiation 3 are at least largely removed. At the same time, this results in a flow-through connection of adjacent recesses 7, when the substrate 2 is in contact, allowing the contacted substrate 2 to be sucked over its surface and fixed in place by the negative pressure. The diameter D of the recesses 7 in the exemplary variant shown is approx. 30 μm to 150 μm, and the distance A of the recesses 7 measured between the respective centers of the recesses 7 is approx. 20 μm to 140 μm, the distance A being smaller than the diameter D. The depressions 9 accordingly form a connected volume.

In the variant shown in FIG. 2, several depressions 9, each with a recess 7 configured as a through-hole 8 can be flow-through and are thus connected to one another in a flow-conducting manner. Several depressions 9 are associated with a suction and/or vacuum opening 12 of a suction unit 14 in a base 13, so that the desired suction can take place through the depressions 9 and the through-hole 8. An exact positioning of the through-hole 8 corresponding to the suction and/or vacuum opening 12, however, is dispensable, so that in use the associated effort is omitted.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

1 substrate carrier
2 substrate
3 electromagnetic radiation
4 substrate support
5 lower side
6 structuring
7 recess
8 through-hole
9 depression
10 wall surface
11 plane
12 vacuum opening
13 base
14 suction unit
D diameter
A spacing

What is claimed is:

1. A substrate carrier made of glass for processing a transparent or transmissive substrate by electromagnetic radiation, the substrate carrier comprising:
a first upper side serving as a substrate support; and
a lower side facing away from the upper side,
wherein the substrate support and/or the lower side of the substrate carrier has a structuring produced by modifications in the substrate carrier and a material removal by action of an etching medium in respective regions of the modifications in the substrate carrier,
wherein the structuring has a plurality of adjacent and/or merging conical recesses, and
wherein at least one of the conical recesses is configured as a through-hole of the substrate carrier between the substrate support and the lower side, and a plurality of other ones of the conical recesses are configured as depressions.

2. The substrate carrier according to claim 1, wherein adjacent ones of the conical recesses are separated from one another by a common wall surface, at least a substantial portion of the common wall surface extending up to a common plane of the substrate support to form a partial and/or punctiform substrate support.

3. The substrate carrier according to claim 1, wherein a contact area of the substrate support with the substrate is less than 1% of areas bounded by a peripheral contour and/or of a projected area of the substrate support.

4. The substrate carrier according to claim 1, wherein at least individual ones of the conical recesses configured as depressions with the at least one conical recess configured as a through-hole are connected to one another in a flow-conducting or flow-through manner in a state in which the substrate is in contact with the substrate carrier.

5. The substrate carrier according to claim 1, wherein the conical recesses configured as depressions are produced from different modifications than the at least one conical recess configured as a through-hole, and undergo a common etching process under corresponding etching conditions such that the different structures arise due to the different modifications.

6. The substrate carrier according to claim 1, wherein different modifications for the conical recesses configured as depressions and the at least one conical recess configured as a though-hole are produced as a result of different focusing, pulse energy and/or power of a laser radiation used for this purpose.

7. The substrate carrier according to claim 1, wherein the conical recesses configured as depressions and the at least one conical resource configured as a through-hole have a corresponding size, area and/or geometry in a plane of the substrate support.

8. The substrate carrier according to claim 1, wherein adjacent ones of the conical recesses are separated from one another by a common wall surface, and wherein the wall surfaces have such a small thickness due to the material removal of the etching treatment that regions with a surface-normal perpendicular to a plane of the substrate support are at least largely excluded.

9. The substrate carrier according to claim 1, wherein the conical recesses configured as depressions have an opening angle of more than 30°, and the at least one conical recess configured as a through-hole has an opening angle of less than 30°.

10. The substrate carrier according to claim 1, wherein the substrate support has, at least in sections, a surface, which is transparent or transmissive for the electromagnetic radiation, and wherein the surface is produced by deposition on the substrate carrier, and has an electrical conductivity.

11. The substrate carrier according to claim 1, wherein each of the substrate support and the lower side have the structuring, and wherein the structuring of the lower side of the substrate carrier has the conical recesses configured as depressions forming a flow-conducting connection for application of suction and/or a vacuum opening to the at least one conical recess configured as a through-hole.

12. A glass blank for producing the substrate carrier according to claim 1, wherein the conical recesses configured as depressions and the at least one recess configured as a through-opening are formed from different modifications, the modifications being set in such a way that individual ones of the conical recesses of the same size, shape and/or geometry of an entirety of the conical recesses are produced in a predetermined plane parallel to a lower side of the blank using an etching treatment with matching parameters in a common etching bath.

13. A device comprising the substrate carrier according to claim 1 for treatment and/or processing of the substrate by the electromagnetic radiation, and a suction and/or vacuum source assigned to the conical recesses.

14. A method for producing a plate-shaped substrate carrier with a first upper side serving as substrate support and a lower side facing away from the upper side, the method comprising:
producing different modifications in the substrate carrier by laser radiation in each case along a beam axis; and then
producing conical recesses to form a structuring on the substrate support and/or the lower side of the substrate carrier by action of an etching medium and by successive etching as a result of anisotropic material removal in respective regions of the modifications in the substrate carrier, wherein the different modifications provide that the conical recesses adjoin and/or merge into one another, with at least one of the conical recesses being configured as a through-hole of the substrate carrier between the substrate support and the lower side, and a plurality of other ones of the conical recesses being configured as depressions without perforations.

15. The method according to claim 14, wherein the conical recesses configured as depressions and the at least one conical recess configured as a through-hole are produced in a common etching process with corresponding etching conditions, whereby the different structures of the conical recesses are formed due to the different modifications as a result of the laser radiation being applied with different focusing, pulse energy and/or power.

16. The method according to claim 14, wherein the conical recesses configured as depressions are modified with a lower power and/or pulse energy of the laser radiation than the at least one recess configured as a through-hole.

17. The method according to claim 14, wherein the different modifications are produced in such a way that, when carrying out the etching treatment, the conical recesses are simultaneously widened until adjacent ones of the conical recesses are separated from one another only by a wall surface that has such a small thickness that regions with a surface-normal perpendicular to a plane of the substrate support are at least largely excluded, and such that the at least one recess configured as a through-hole extends between the substrate support and the lower side.
